(19) United States
(12) Patent Application Publication
(10) Pub. No.: US 2021/0180875 A1
(43) Pub. Date: Jun. 17, 2021

(54) HEAT SINK FOR 3D PRINTER

(71) Applicants: XYZprinting, Inc., New Taipei City (TW); Kinpo Electronics, Inc., New Taipei City (TW)

(72) Inventors: Chung-Yen Gir, New Taipei City (TW); Tsung-Hua Kuo, New Taipei City (TW)

(73) Assignees: XYZprinting, Inc., New Taipei City (TW); Kinpo Electronics, Inc., New Taipei City (TW)

(21) Appl. No.: 16/783,177

(22) Filed: Feb. 6, 2020

(30) Foreign Application Priority Data
Dec. 12, 2019 (CN) 201911274438.8

(51) Int. Cl. F28D 15/02

(52) U.S. Cl. CPC F28D 15/0275

(57) ABSTRACT

A heat sink for a 3D printer includes a storage tank, a pipe loop, a pump, a heat dissipation unit, and a release film. The storage tank is configured to contain a printing material. The pipe loop is connected to the storage tank. The pump is connected to the pipe loop and configured to pump the printing material from the storage tank, so that the printing material circulates through the pipe loop. The heat dissipation unit is connected to the pipe loop. The printing material is pumped into the pipe loop, then subjected to heat dissipation by the heat dissipation unit, and re-injected into the storage tank successively. The release film is disposed at a bottom of the storage tank.

### CROSS-REFERENCE TO RELATED APPLICATION

This application claims the priority benefit of China application no. 201911274438.8, filed on Dec. 12, 2019. The entirety of the above-mentioned patent application is hereby incorporated by reference herein and made a part of this specification.

### BACKGROUND OF THE INVENTION

### 1. Field of the Invention

The invention relates to a heat sink, and more particularly, to a heat sink applied to a 3D printer.

### 2. Description of Related Art

Photocurable resin is usually used as a printing material in a 3D printer. Since high heat is generated when the printing material is cured, especially when the 3D printer is printing fast, a large amount of heat generated in a short time is difficult to dissipate and thus accumulates in the 3D printer, which may affect parts that may contact the photocurable resin, thereby affecting the printing effect and causing the overall use efficiency of the 3D printer to deteriorate.

### SUMMARY OF THE INVENTION

The invention provides a heat sink for a 3D printer.

A heat sink for a 3D printer of the invention includes a storage tank, a pipe loop, a pump, a heat dissipation unit, and a release film. The storage tank is configured to contain a printing material; the pipe loop is connected to the storage tank; the pump is connected to the pipe loop and configured to pump the printing material from the storage tank, so that the printing material circulates through the pipe loop; the heat dissipation unit is connected to the pipe loop, wherein the printing material is pumped into the pipe loop, then subjected to heat dissipation by the heat dissipation unit, and re-injected into the storage tank successively; and the release film is disposed at a bottom of the storage tank.

In an embodiment of the invention, the pipe loop includes an injection pipe and an output pipe, the injection pipe being connected to one side of the storage tank, and the output pipe being connected to another side of the storage tank.

In an embodiment of the invention, the injection pipe and the output pipe are connected to two opposite sides of the storage tank.

In an embodiment of the invention, the heat sink further includes a guide plate disposed in the storage tank and configured to guide flowing of the printing material in the storage tank.

In an embodiment of the invention, the heat sink further includes at least one filter screen disposed relative to at least one of the injection pipe and the output pipe.

In an embodiment of the invention, the heat dissipation unit includes a heat pipe and a heat dissipation fin, the heat pipe passing through the heat dissipation fin to be connected between the injection pipe and the output pipe.

In an embodiment of the invention, the pump is connected between the heat dissipation unit and the output pipe.

In an embodiment of the invention, the heat dissipation unit further includes at least one fan disposed relative to the heat pipe.

Based on the above, in the heat sink for the 3D printer of the invention, the printing material is drawn out of the storage tank for heat dissipation and then re-injected into the storage bank, which may effectively reduce accumulated heat in the storage tank, thereby improving the overall use efficiency of the 3D printer.

### BRIEF DESCRIPTION OF THE DRAWINGS

FIG. 1 is a schematic diagram of a heat sink for a 3D printer.

FIG. 2 is a top view of the heat sink of FIG. 1.

FIG. 3A to FIG. 3C are each a schematic top view showing a possible manner in which the storage tank, the injection pipe, and the output pipe are disposed.

FIG. 4 is a schematic side view showing a possible manner in which the injection pipe and the output pipe are disposed.

### DESCRIPTION OF THE EMBODIMENTS

In the 3D printing technology, a printing material that is usually used is photocurable resin, and during 3D printing, faster curing of the photocurable resin leads to faster accumulation of heat. Therefore, heat dissipation of the printing material is necessary.

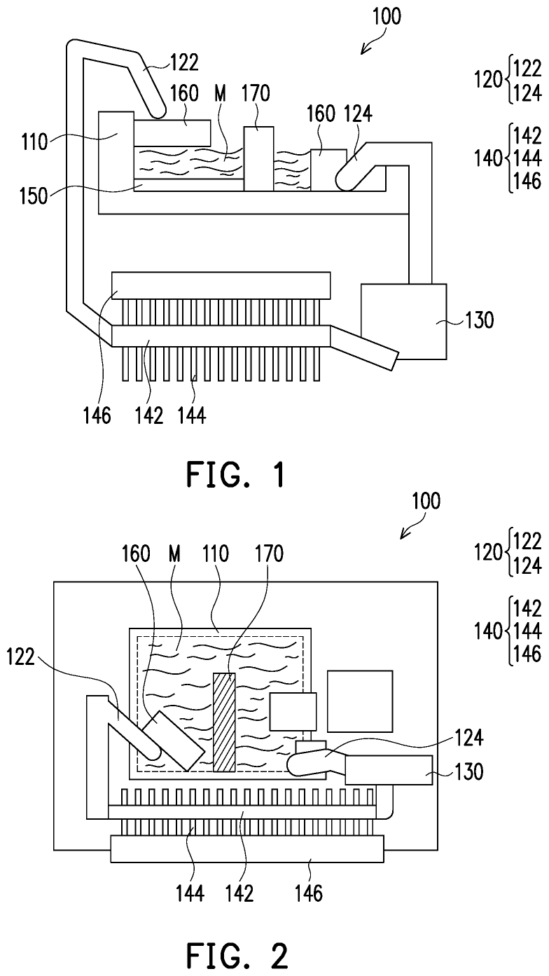

FIG. 1 is a schematic diagram of a heat sink for a 3D printer, and FIG. 2 is a top view of the heat sink of FIG. 1. Referring to FIG. 1 and FIG. 2 together, a heat sink 100 for a 3D printer includes a storage tank 110, a pipe loop 120, a pump 130, a heat dissipation unit 140, and a release film 150. The storage tank 110 is configured to contain a printing material M; the pipe loop 120 is connected to the storage tank 110; the pump 130 is connected to the pipe loop 120 and is configured to pump the printing material M from the storage tank 110, so that the printing material circulates through the pipe loop 120; the heat dissipation unit 140 is connected to the pipe loop 120, wherein the printing material M is pumped into the pipe loop 120, then subjected to heat dissipation by the heat dissipation unit 140, and re-injected into the storage tank 110 successively; and the release film is 150 disposed at a bottom of the storage tank 110.

The pipe loop 120 that is connected to the storage tank 110 includes an injection pipe 122 and an output pipe 124, the injection pipe 122 being connected to one side of the storage tank 110, and the output pipe 124 being connected to another side of the storage tank 110.

The heat sink 100 further includes at least one filter screen 160 disposed relative to at least one of the injection pipe 122 and the output pipe 124. In the present embodiment, filter screens 160 may be disposed at both the injection pipe 122 and the output pipe 124 to filter out impurities.

Further to the above description, the heat dissipation unit 140 includes a heat pipe 142 and a heat dissipation fin 144, wherein the heat pipe 142 passes through the heat dissipation fin 144 to be connected between the injection pipe 122 and the output pipe 124, and the pump 130 is connected between the heat dissipation unit 140 and the output pipe 124. In another embodiment, the heat pipe 142 may be replaced with a liquid cooler.

When 3D printing is performed, heat generated due to the curing of the printing material M is transferred to the uncured printing material M, so heat may be accumulated in the storage tank 110. If the heat accumulated in the storage tank 110 cannot be dissipated in time, the release film 150 may be melted, and the storage tank 110 or a semi-finished product under formation through 3D printing may also be affected.

In this case, a portion of the printing material M flows out of the output pipe 124 through pumping of the pump 130.

The printing material M flowing out of the output pipe 124 enters the heat dissipation unit 140 for heat dissipation. Specifically, the printing material M enters the heat pipe 142, and the heat is dissipated through the heat pipe 142 and the heat dissipation fin 144, so that the printing material M may be effectively cooled.

Incidentally, in order to enhance the heat dissipation effect, the heat dissipation unit 140 may further include at least one fan 146, the fan 146 being disposed relative to the heat pipe 142 and being configured to blow the heat pipe 142 to cause forced convection, thereby improving heat dissipation effects of the heat pipe 142 and the heat dissipation fin 144.

The cooled printing material M is re-injected into the storage tank 110 through the injection pipe 122, and exchanges heat with the printing material M with accumulated heat in the storage tank 110. In this way, the overall temperature of the printing material M in the storage tank 110 may be effectively reduced.

It should be noted that, in the present embodiment, the injection pipe 122 and the output pipe 124 are connected to two opposite sides of the storage tank 110, but they are not limited to the manner described in the present embodiment.

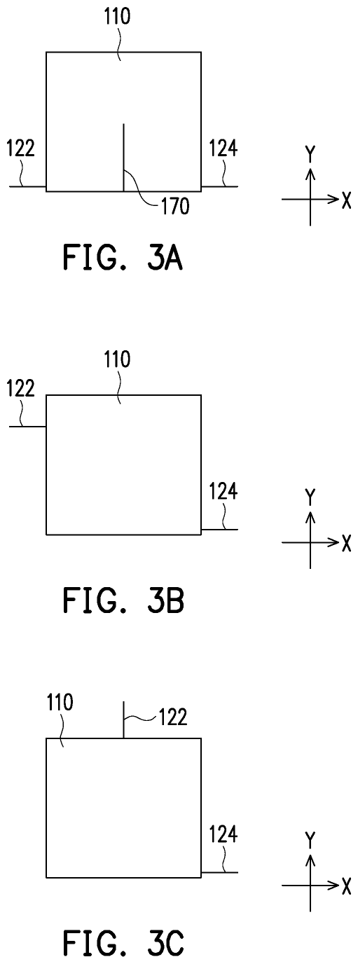

FIG. 3A to FIG. 3C are each a schematic top view showing a possible manner in which the storage tank 110, the injection pipe 122, and the output pipe 124 are disposed. As shown in FIG. 3A, in an XY plane, the injection pipe 122 and the output pipe 124 are disposed on two opposite sides of the storage tank 110, and the injection pipe 122 and the output pipe 124 may have a same height in a Y direction. Alternatively, as shown in FIG. 3B, the injection pipe 122 and the output pipe 124 may have different heights in the Y direction. Alternatively, as shown in FIG. 3C, the injection pipe 122 and the output pipe 124 are not disposed on two opposite sides of the storage tank 110, but are disposed on two connected sides of the storage tank 110.

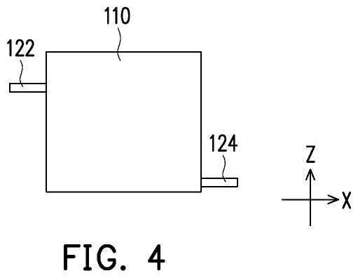

FIG. 4 is a schematic side view showing a possible manner in which the injection pipe 122 and the output pipe 124 are disposed. Alternatively, as shown in FIG. 4, the injection pipe 122 and the output pipe 124 may have different heights in a Z direction, wherein a height of the injection pipe 122 is higher than a height of the output pipe 124.

It may be learned from the above that positions at which the injection pipe 122 and the output pipe 124 are disposed may be changed according to actual requirements.

In addition, the heat sink 100 may further include a guide plate 170 additionally disposed in the storage tank 110, wherein the guide plate 170 is configured to guide flowing of the printing material M in the storage tank 110, so that the lower-temperature printing material M entering the storage tank 110 from the injection pipe 122 may flow in the storage tank 110 in a sinuous manner, to effectively perform heat exchange with the higher-temperature printing material M, and to avoid a case in which, due to pumping of the pump 130, the lower-temperature printing material M flows out of the storage tank 110 directly through the output pipe 124 in a linear flowing manner after entering the storage tank 110 from the injection pipe 122, and cannot perform effective heat exchange with the higher-temperature printing material M in the storage tank 110.

The foregoing changes in the positions at which the injection pipe 122 and the output pipe 124 are disposed may also achieve the same effect as the manner in which the guide plate 170 is disposed in the storage tank 110. Fluidity of the printing material M in the storage tank 110 is increased to achieve effective heat exchange.

Definitely, the fluidity of the printing material M in the storage tank 110 is not limited to being increased in the foregoing manner, which may alternatively be increased in a disturbance manner to improve the effect of heat exchange. For example, the storage tank 110 may be slightly vibrated, or a disturbance element may be disposed in a storage layer, which may also increase the fluidity of the printing material M in the storage tank 110 to improve the efficiency of heat exchange.

Based on the above, in the heat sink for the 3D printer of the invention, the printing material is drawn out of the storage tank for heat dissipation and then re-injected into the storage bank, which may effectively reduce heat accumulation in the storage tank, so that the overall temperature of the printing material in the storage tank may be effectively reduced, further preventing the release film disposed at the bottom of the storage tank from being melted, and improving the printing quality.

What is claimed is:

1. A heat sink for a 3D printer, comprising:
a storage tank configured to contain a printing material;
a pipe loop connected to the storage tank;
a pump connected to the pipe loop and configured to pump the printing material from the storage tank, so that the printing material circulates through the pipe loop;
a heat dissipation unit connected to the pipe loop, wherein the printing material is pumped into the pipe loop, then subjected to heat dissipation by the heat dissipation unit, and re-injected into the storage tank successively; and
a release film disposed at a bottom of the storage tank.

2. The heat sink for the 3D printer according to claim 1, wherein the pipe loop comprises an injection pipe and an output pipe, the injection pipe being connected to one side of the storage tank, and the output pipe being connected to another side of the storage tank.

3. The heat sink for the 3D printer according to claim 2, wherein the injection pipe and the output pipe are connected to two opposite sides of the storage tank.

4. The heat sink for the 3D printer according to claim 3, further comprising a guide plate disposed in the storage tank and configured to guide flowing of the printing material in the storage tank.

5. The heat sink for the 3D printer according to claim 2, further comprising at least one filter screen disposed relative to at least one of the injection pipe and the output pipe.

6. The heat sink for the 3D printer according to claim 2, wherein the heat dissipation unit comprises a heat pipe and a heat dissipation fin, the heat pipe passing through the heat dissipation fin to be connected between the injection pipe and the output pipe.

7. The heat sink for the 3D printer according to claim 6, wherein the pump is connected between the heat dissipation unit and the output pipe.

8. The heat sink for the 3D printer according to claim 6, wherein the heat dissipation unit further comprises at least one fan disposed relative to the heat pipe.
